(19) United States
(12) Patent Application Publication
(10) Pub. No.: US 2017/0356201 A1
(43) Pub. Date: Dec. 14, 2017

(54) PROTECTIVE BARRIER COMPRISING A SEAM HAVING AN INTEGRATED DUSTCOVER SYSTEM AND A METHOD FOR ITS USE

(71) Applicant: David Landis Campbell, Harleysville, PA (US)

(72) Inventor: David Landis Campbell, Harleysville, PA (US)

(21) Appl. No.: 15/268,243

(22) Filed: Sep. 16, 2016

Related U.S. Application Data
(63) Continuation-in-part of application No. 15/179,614, filed on Jun. 10, 2016.

(51) Int. Cl. E04G 21/30; B29C 65/02; B29C 65/62; B29C 65/00; E04G 21/28; B29L 31/00

(52) U.S. Cl. CPC E04G 21/30; B29C 66/1142; E04G 21/28; B29C 65/02; B29C 65/62; B29C 66/435; B29L 2031/768; B29K 2623/06

(57) ABSTRACT

The present protective barrier is similar to those commonly installed beneath ceilings during construction work being performed on ceilings or roofs of buildings, wherein two or more sections are sewn together to construct the protective barrier. However, the present protective barrier also comprises a dustcover, which covers the seam entirely preventing dust from passing through holes created when the seam is sewn using a thread or similar means.

### CROSS REFERENCE TO RELATED APPLICATIONS

This application is a continuation-in-part of nonprovisional application Ser. No. 15/179,614 filed Jun. 10, 2016.

### FIELD OF THE INVENTION

The present device relates to an improvement to protective barriers that are commonly installed beneath ceilings and in place of walls in buildings that are under construction or being renovated to protect selected areas from dust and moisture created by or permitted to enter due to the work being performed.

### BACKGROUND

Protective barriers, such as those described herein, are commonly used to prevent dust, debris and moisture from falling onto floors, people, merchandise and equipment located below ceilings or roofs being repaired or constructed. In this way, the protective barrier protects from added costs from damage or injury resulting from such falling material and encroaching moisture and can allow work to continue below the ceiling or roof under construction. Such barriers are commonly constructed from interconnected sections of polyethylene sheets or similar materials, which have proven to be durable, easy to work with, and relatively inexpensive.

However, a problem exists with this type or protective barrier, which can allow some dust to pass through the barrier. Specifically, a protective barrier can comprise sections of polyethylene sheets or similar materials connected by seams which are typically made by sewing two or more sections together with thread. The sewing of these seams results in thousands of holes created when a needle, used to sew the sections together, pierces the sections to allow the thread to pass through them to bind them together. These holes create passageways through which dust and other powdery substances can travel, thus circumventing the purpose of the protective barrier.

What is needed is a protective barrier comprising sections connected by seams sewn together in a way that prevents dust from being able to pass through the holes created by the sewing.

### SUMMARY OF THE INVENTION

It is an aspect of the present inventive concept to provide a seam for connecting sections of material, which can be configured to prevent dust from being able to pass through the holes created by the sewing together of two or more sections of polyethylene sheets or similar materials.

The above aspects can be obtained by a protective barrier comprising a first section and a second section connected by an abutted seam where the first section and second section are abutted against each other and are connected by a thread, the seam also comprising a dustcover system comprising a first dustcover section connected to the first section and a second dustcover section connected to the second section, wherein the abutted seam is at least partially covered by a part of the first dustcover section and a part of the second dustcover section.

The above aspects can also be obtained by a protective barrier comprising a first section and a second section connected by an overlapping seam where the first section and second section overlap each other and are connected by a thread, the seam also comprising a dustcover system comprising a first dustcover section connected to the first section and a second dustcover section connected to the second section, wherein the overlapping seam is at least partially covered by a part of the first dustcover section and a part of the second dustcover section.

The above aspects can also be obtained by a method for constructing a protective barrier, the method comprising: providing parts of a protective barrier, comprising a first section and a second section, a dustcover system comprising a first dustcover section and a second dustcover section, adhesive, and a thread; abutting the first section against the second section and sewing the first section and second section together with the thread creating an abutted seam; connecting the first dustcover section to the first section with adhesive so that at least part of the first dustcover section covers the abutted seam; and connecting the second dustcover section to the second section with adhesive so that at least part of the second dustcover section covers the abutted seam.

These together with other aspects and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a perspective drawing of a prior art seam connecting two sections of polyethylene sheets or similar materials to create a protective barrier;

FIG. 2 is a side, cutaway view of the prior art seam shown in FIG. 1 connecting two sections of polyethylene sheets or similar materials comprising the protective barrier through which a dust or similar powder is shown passing through the seam;

FIG. 3 is a perspective drawing of an abutted seam connecting two sections of polyethylene sheets or similar materials comprising a protective barrier, wherein the abutted seam comprises a dustcover system that does comprise and adhesive, according to an embodiment;

FIG. 4 is a side, cutaway view of an abutted seam connecting two sections of polyethylene sheets or similar materials comprising a protective barrier, as shown in FIG. 3, wherein the abutted seam comprises a dustcover system that does comprise and adhesive, according to an embodiment;

FIG. 5 is an exploded view of the abutted seam connecting two sections of polyethylene sheets or similar materials comprising the protective barrier as shown in FIGS. 3 and 4, wherein the abutted seam comprises a dustcover system that does comprise and adhesive, according to an embodiment;

FIG. 6 is a perspective drawing of an overlapping seam connecting a first section and a second section comprising a protective barrier, each comprised of polyethylene sheets or similar materials, wherein the overlapping seam comprises a dustcover system that does comprise and adhesive, according to an alternative embodiment;

FIG. 7 is a side, cutaway view of the overlapping seam connecting two sections of polyethylene sheets or similar materials comprising a protective barrier, as shown in FIG. 6, wherein the overlapping seam comprises a dustcover system that does comprise and adhesive, according to an embodiment;

FIG. 8 is an exploded view of the overlapping seam shown in FIG. 6 connecting the first section and second section comprising a protective barrier, wherein each is comprised of polyethylene or similar materials comprising a protective barrier, wherein the overlapping seam comprises a dustcover system that does comprise and adhesive, according to an alternative embodiment;

FIG. 9 is a perspective drawing of an abutted seam connecting two sections of polyethylene sheets or similar materials comprising a protective barrier, wherein the abutted seam comprises a dustcover system that does not comprise and adhesive, according to an embodiment;

FIG. 10 is a side, cutaway view of an abutted seam connecting two sections of polyethylene sheets or similar materials comprising a protective barrier, as shown in FIG. 9, wherein the abutted seam comprises a dustcover system that does not comprise and adhesive, according to an embodiment; and

FIG. 11 is an exploded view of the abutted seam connecting two sections of polyethylene sheets or similar materials comprising the protective barrier as shown in FIGS. 9 and 10, wherein the abutted seam comprises a dustcover system that does not comprise and adhesive, according to an embodiment.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Reference will now be made in detail to the presently preferred embodiments of the present inventive concept, examples of which are illustrated in the accompanying drawings, wherein like reference numerals refer to like elements throughout.

The present dustcover systems can be used to solve the problem created when two or more sections of polyethylene, or similar materials, are sewn together creating holes through each. Polymers, such as polyethylene, have many attractive features when used as protective barriers including the fact that they are impermeable to almost all types of liquids, powders and small debris including dust and water, and they are relatively inexpensive per square foot of coverage. However, a disadvantage of polymers, such as polyethylene, is that, unlike fabrics, holes created when a needle and thread are placed through them do not close or even get smaller over time. Rather, such holes stay the same size as when they were created or get larger and create passageways sufficiently large for dust and water to travel through thus reducing the effectiveness of the protective barrier. The present dustcover systems can prevent dust from passing through these holes by covering them with dustcover sections, which are attached near the seam and can interlock over the seam in some embodiments. These dustcover systems can completely cover the seams further inhibiting the flow of dust and water through the seam, according to some embodiments.

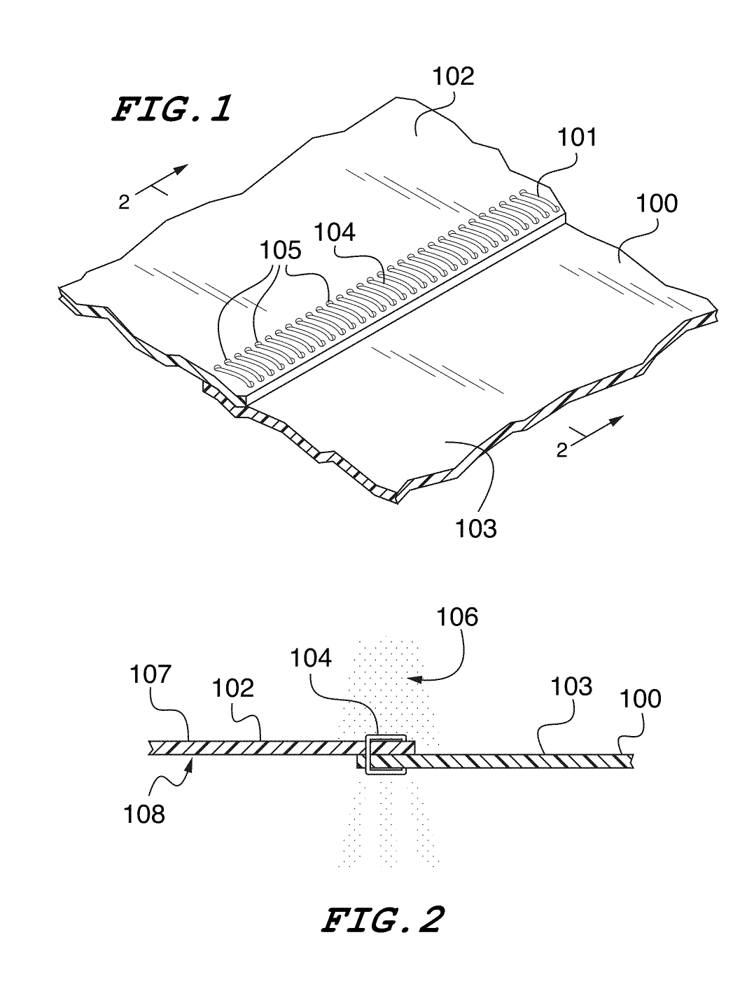

FIG. 1 is a perspective drawing of a protective barrier 100 comprising an overlapping seam 101, which is part of the prior art, connecting a first section 102 of polyethylene sheet or similar material to a second section 103 of polyethylene sheet or similar material using a thread 104, according to an embodiment. In this representational view of the prior art, holes 105 are created each time the thread 104 passes through the first section 102 and second section 103 to create the overlapping seam 101. As discussed above, these holes 105 are sufficiently large to allow dust and similar material to pass through them, thus by-passing and defeating the purpose of the protective barrier 100.

FIG. 2 is a side, cutaway view of the overlapping seam 101, which is part of the prior art, comprising the protective barrier 100 shown in FIG. 1. In this view, the thread 104 comprising the overlapping seam 101 is shown connecting the first section 102 to the second section 103 and dust 106 is shown passing from an outer, unprotected side 107 of the protective barrier 100 to an inner, protected side 108 of the protective barrier 100. This passage of dust can be prevented by the present apparatus, in its various embodiments, which are explained in detail below.

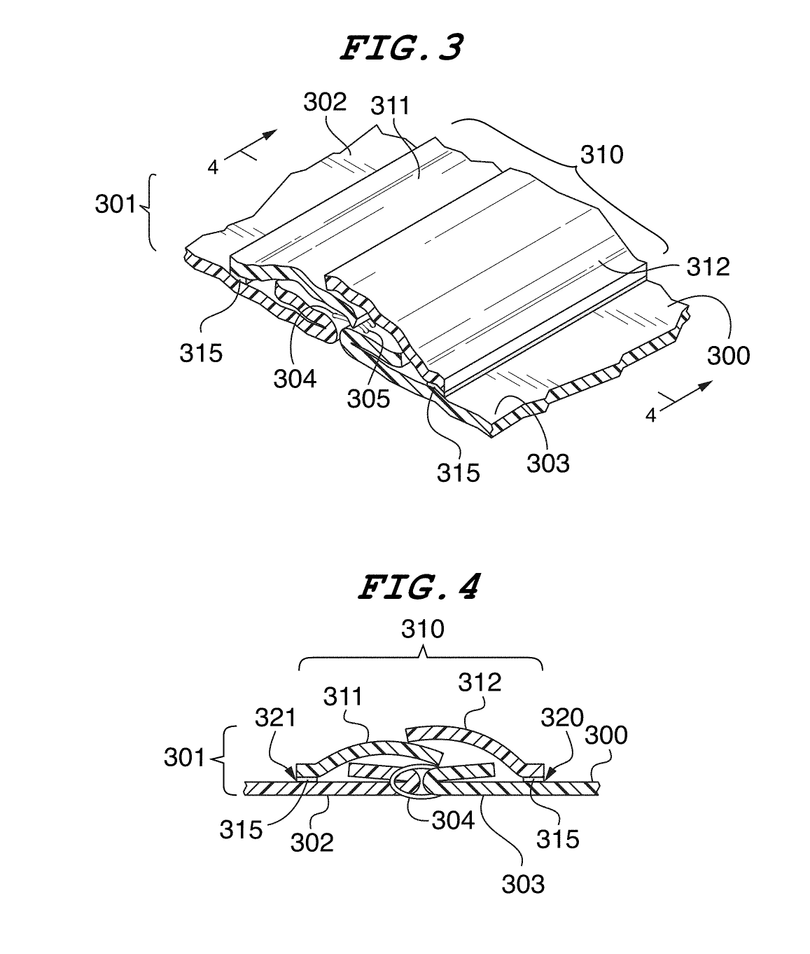

FIG. 3 is a perspective drawing of an abutted seam 301 connecting a first section 302 to a second section 303 of a protective barrier 300, wherein the abutted seam 301 comprises a dustcover system 310 comprising an adhesive 315, according to an embodiment.

This dustcover system 310 can be comprised of a first dustcover section 311 and a section dustcover section 312. According to an embodiment, both the first dustcover section 311 and the second dustcover section 312 can be configured to fold over the seam 301, thus preventing dust (not pictured in FIG. 3) from being allowed to pass through the holes 305 created by the thread 304. Specifically, according to an embodiment, the dustcover sections 312 and 313 can be comprised of a polyethylene or similar material which can be made to retain a shape configured to bend over the seam 301 and stay in that position. In addition, the dustcover 310 can be applied after the seam 301 has been sewn, therefore not interfering with the sewing process.

The thread 304, comprising a protective barrier 300, can be made from any standard material used to create thread, including nylon, cotton, silk, polypropylene, polyester and any number of other natural or synthetic materials, which are commonly used to manufacture thread. However, in an embodiment the thread 304 can be comprised of a water soluble material such as polyvinyl alcohol, which can disintegrate when contacted by water allowing the seam 301 to come apart. The benefits of protective barriers comprising such seems have been described in U.S. patent application Ser. No. 13/964,968, which is incorporated by reference herein in its entirety. Similarly, in an alternative embodiment the thread 304 can be comprised of a heat sensitive material such as a copolyamide or polycaprolacone, which can disintegrate when subjected to temperatures between 140 degrees and 180 degrees Celsius allowing the seam 301 to come apart at those temperatures. The benefits of protective barriers comprising such seems have been described in U.S. patent application Ser. No. 13/965,137, which is also incorporated by reference herein in its entirety.

FIG. 4 is a side, cutaway view of the protective barrier 300, as shown in FIG. 3, comprising an abutted seam 301 connecting a first section 302 to a second section 303, wherein the seam comprises a dustcover system 310 comprising an adhesive 315, according to an embodiment. In this figure, the shape of the first dustcover section 311 and the shape of the second dustcover section 312 can each be seen clearly. Specifically, each dustcover section is shown to be an arc-shaped flap, wherein each is facing in an opposite direction, according to an embodiment. As shown, the abutted seam 301 comprises the thread 304 followed by the folded over end of the first section 302 connecting the folded over end of the second section 303. In an embodiment, the first dustcover section 311 can have an arc-shape with an opening to the right and a connection point to the first section 302 on the left. The connection point on the left can be created using a layer of adhesive 315 which connects the first dustcover section 311 to the first section 302 at a first determined point 320. In an embodiment, this first determined point 320 can be far enough from the abutted seam 301 so as not to interfere with it, but close enough to allow the first dustcover section 311 to pass partially or fully over the abutted seam 301.

Similarly, the second dustcover section 312 can have an arc-shape with an opening to the left and a connection point to the first section 302 on the right. The connection point on the right can be created using a layer of adhesive 315 which connects the second dustcover section 312 to the second section 303 at a second determined point 321. As with the first determined point 320, the second determined point 321 can be far enough from the abutted seam 301 so as not to interfere with it, but close enough to allow the second dustcover section 312 to pass partially or fully over the abutted seam 301 and partially over the first dustcover section 311. As shown in FIGS. 3 and 4, the thread 304 and the holes 305 can be covered by the dust cover sections, 311 and 312, comprising the dustcover system 310. In this embodiment, the dust cover sections, 311 and 312, comprising the dustcover system 310 do not interfere with the abutted seam 301. Rather, the dustcover system 310 connected to the first section 302 and the second section 303 in close proximity to the abutted seam 301 where the first dustcover section 311 and the second dustcover section 312 cover and protect the abutted seam 101 without being part of it, allowing for a simpler seam, which is an advantage of the present embodiment. Once the first dustcover section 311 and the second dustcover section 312 are in place, as shown in FIGS. 3 and 4, there are no uncovered holes 305 available for dust or similar debris to pass through the protective barrier 300.

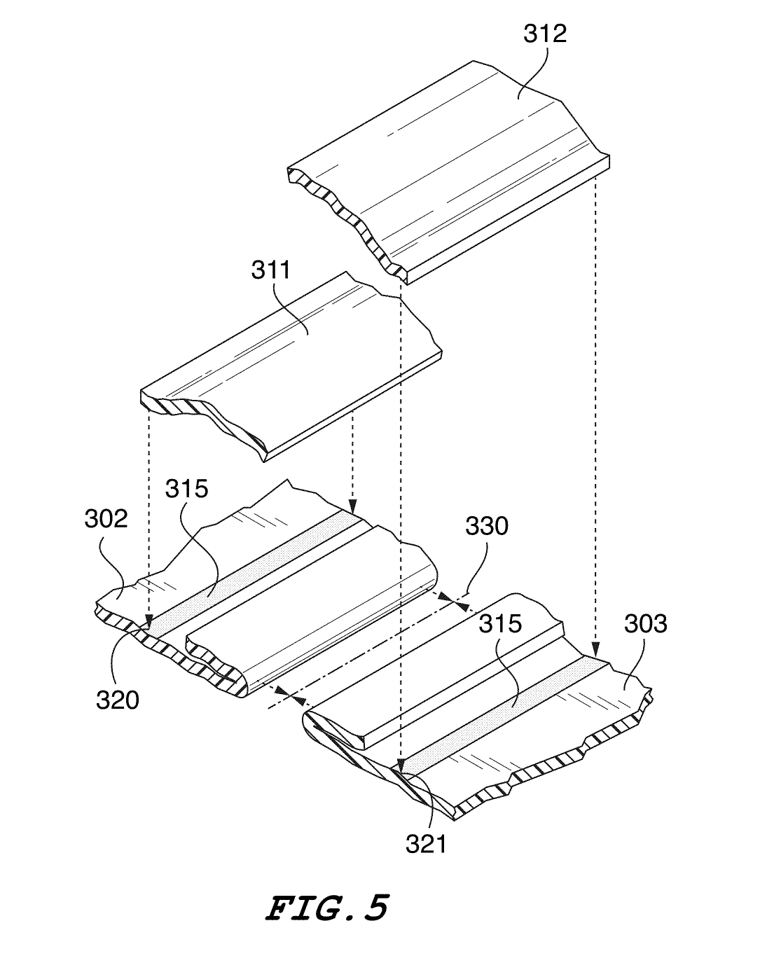

FIG. 5 is an exploded view of the first section 302, the second section 303, the first dustcover section 311 and the second dustcover section 312, wherein the dustcover system 310 comprises an adhesive layer 315, according to an embodiment. This view shows the protective barrier 300 having an abutted seam 301 as shown in FIGS. 3 and 4. In this view the placement of the adhesive layer 315 can be along a line extending from the first determined point 320, parallel to the meeting point 330 of the first section 302 and the second section 303, and similarly and adhesive layer 315 can also be along a line extending from the second determined point 321 parallel to the meeting point 330 of the first section 302 and the second section 303.

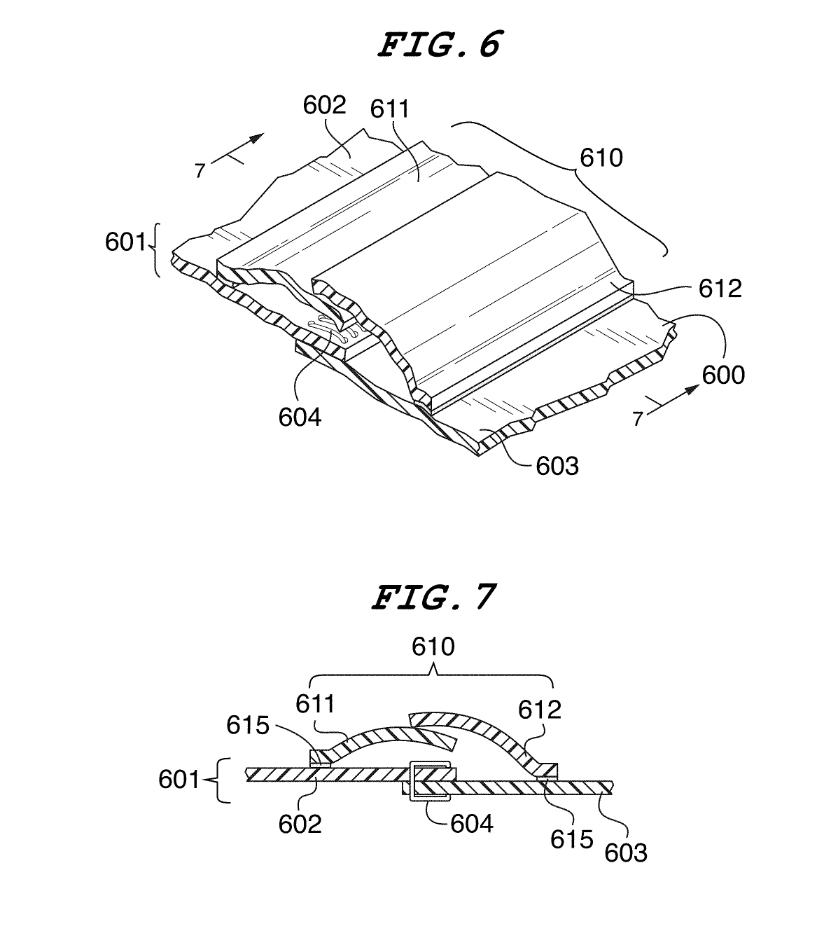

FIG. 6 is a perspective drawing of an of overlapping seam 601 connecting a first section 602 and a second section 603 comprising a protective barrier 600, each comprised of polyethylene sheets or similar materials, wherein the overlapping seam 601 comprises a dustcover system 610 comprising an adhesive layer 615, according to an alternative embodiment. This embodiment, as represented in FIGS. 6, 7 and 8, is identical to that described and shown in FIGS. 3,4 and 5 except that the latter seam is an overlapping seam 601 rather than the abutted seam 301 shown in the previous three figures. Specifically, this embodiment, the protective barrier 600, still comprises a first section 602 and a second section 603 joined by a seam 601 and that seam is protected by a dustcover system 610 comprising a first dustcover section 611 and a second dustcover section 612, wherein the dustcover sections, 611 and 612, are connected to the respective sheets with an adhesive layer 615.

The thread 604, comprising a protective barrier 600, can be made from any standard material used to create thread, including nylon, cotton, silk, polypropylene, polyester and any number of other natural or synthetic materials, which are commonly used to manufacture thread. However, in an embodiment the thread 604 can be comprised of a water soluble material such as polyvinyl alcohol, which can disintegrate when contacted by water allowing the seam 601 to come apart. The benefits of protective barriers comprising such seems have been described in U.S. patent application Ser. No. 13/964,968, which is incorporated by reference herein in its entirety. Similarly, in an alternative embodiment the thread 604 can be comprised of a heat sensitive material such as a copolyamide or polycaprolacone, which can disintegrate when subjected to temperatures between 140 degrees and 180 degrees Celsius allowing the seam 601 to come apart at those temperatures. The benefits of protective barriers comprising such seems have been described in U.S. patent application Ser. No. 13/965,137, which is also incorporated by reference herein in its entirety.

FIG. 7 is a side, cutaway view of the overlapping seam 601 connecting the two sections, 602 and 603, of polyethylene sheets or similar materials comprising a protective barrier 600, as shown in FIG. 6, wherein the overlapping seam comprises a dustcover system 610 that comprises an adhesive layer 615, according to an embodiment.

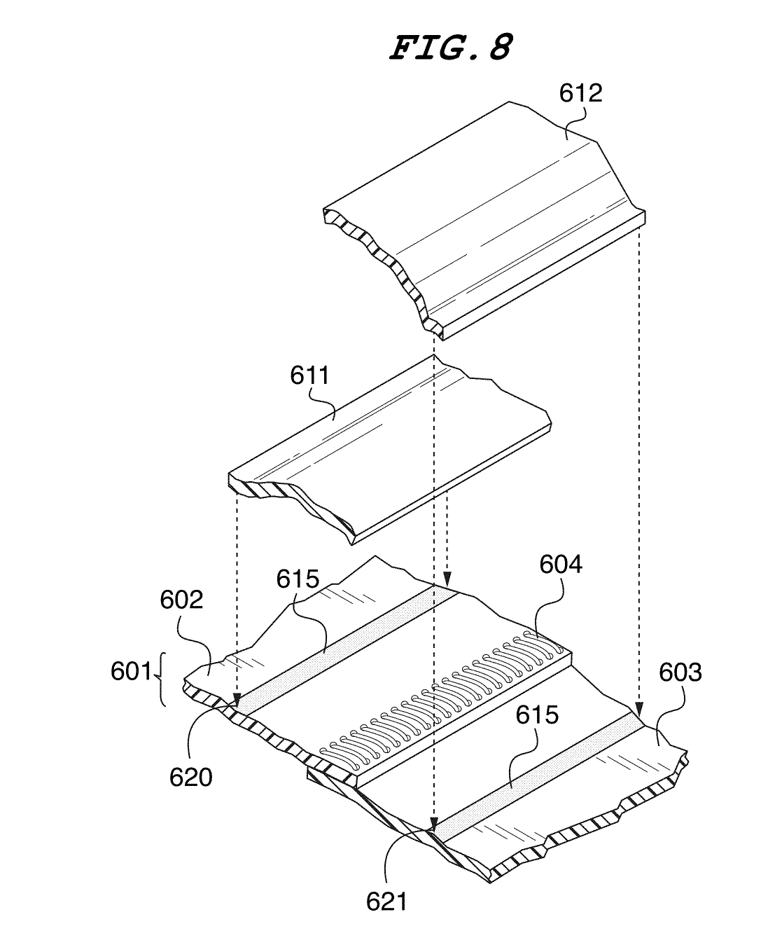

FIG. 8 is an exploded view of the overlapping seam 601 shown in FIG. 6 connecting the first section 611 and second section 612 comprising a protective barrier 600, wherein each is comprised of polyethylene or similar materials and wherein the overlapping seam comprises a dustcover system 610, as shown in FIGS. 6 and 7 comprising an adhesive, layer 615 according to an alternative embodiment. Similar to the first embodiment shown in FIGS. 3 thru 5, the placement of the adhesive layer 615 on the first section 602 can be along a line extending from the first determined point 620 and extending parallel to the overlapping seam 601, and another adhesive layer 615 on the second section 603 can also be along a line extending from the second determined point 621 and extending parallel to the overlapping seam 601.

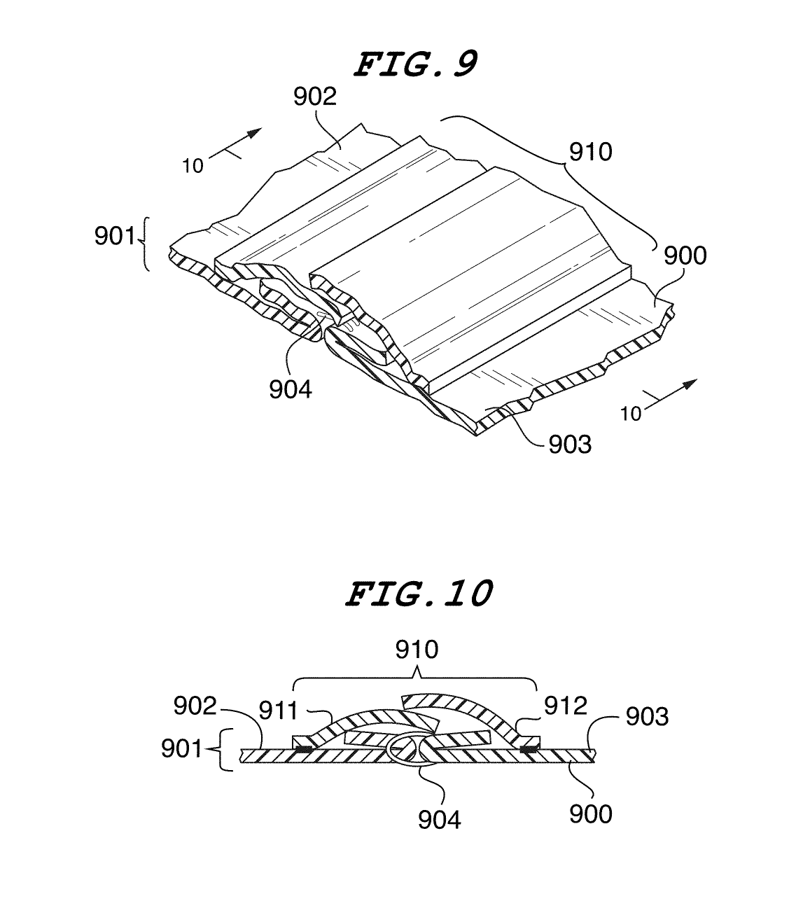

FIGS. 9, 10 and 11 show a protective barrier, having an abutted seam connecting a first section and a second section and dustcover system protecting the abutted seam, identical to the configuration of the protective barrier 300 shown in FIGS. 3, 4 and 5 except that this embodiment does not use one or more adhesive layers to connect the dustcover system to the first and second sections.

FIG. 9 is a perspective drawing of an abutted seam 901 having a thread 904 connecting a first section 902 and a second section 903 comprising a protective barrier 900 comprised of polyethylene sheets or similar materials comprising a protective barrier, wherein the abutted seam 901 is protected by a dustcover system 910 that does not comprise an adhesive layer, but may be connected by an ultrasonic-welded seam, a heat-welded seam or similar system of connecting one polymer to another without creating holes in the polymers, according to an embodiment.

As with the other embodiments described above, the thread 904, comprising a protective barrier 900, can be made from any standard material used to create thread, including nylon, cotton, silk, polypropylene, polyester and any number of other natural or synthetic materials, which are commonly used to manufacture thread. However, in an embodiment the thread 904 can be comprised of a water soluble material such as polyvinyl alcohol, which can disintegrate when contacted by water allowing the seam 901 to come apart. The benefits of protective barriers comprising such seems have been described in U.S. patent application Ser. No. 13/964,968, which is incorporated by reference herein in its entirety. Similarly, in an alternative embodiment the thread 904 can be comprised of a heat sensitive material such as a copolyamide or polycaprolacone, which can disintegrate when subjected to temperatures between 140 degrees and 180 degrees Celsius allowing the seam 901 to come apart at those temperatures. The benefits of protective barriers comprising such seems have been described in U.S. patent application Ser. No. 13/965,137, which is also incorporated by reference herein in its entirety.

FIG. 10 is a side, cutaway view of the abutted seam 901 connecting two sections, 911 and 912, of polyethylene sheets or similar materials comprising a protective barrier 900, as shown in FIG. 9, wherein the abutted seam 901 comprises a dustcover system 910 that does not comprise an adhesive layer, but may be connected by an ultrasonic-welded seam, a heat-welded seam or similar system of connecting one polymer to another without creating holes in the polymers, according to an embodiment.

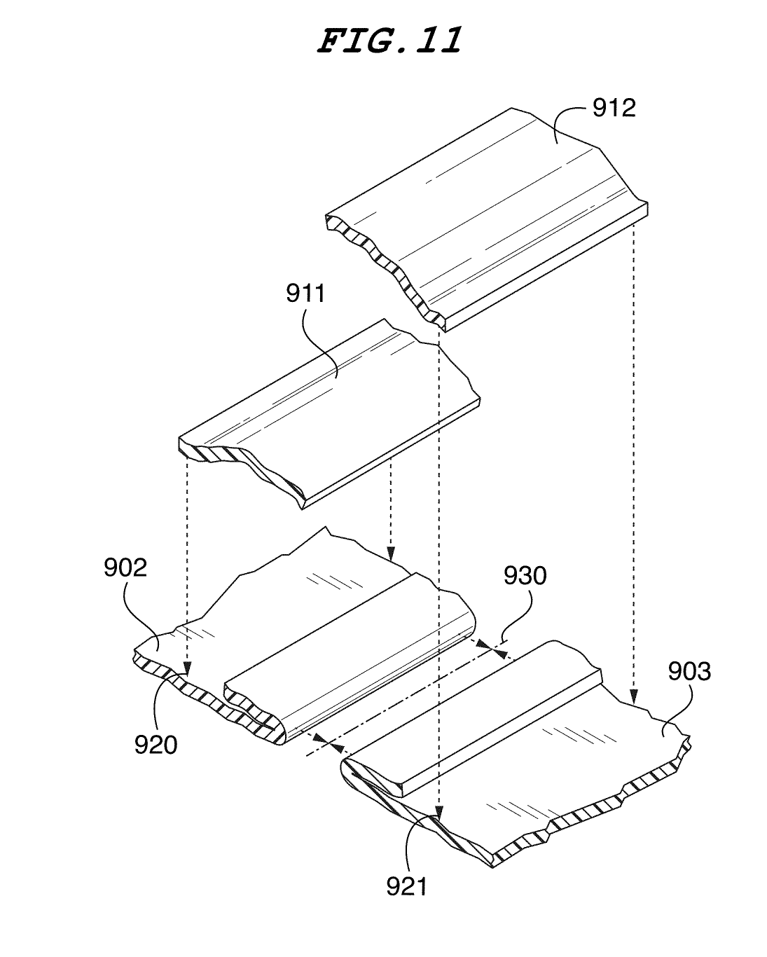

FIG. 11 is an exploded view of the abutted seam 901 connecting two sections of polyethylene sheets or similar materials comprising the protective barrier as shown in FIGS. 9 and 10, wherein the abutted seam comprises a dustcover system that does not comprise an adhesive, but may be connected by an ultrasonic-welded seam, a heat-welded seam or similar system of connecting one polymer to another without creating holes in the polymers according to an embodiment.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A protective barrier, comprising:
a first section and a second section connected by an abutted seam where the first section and second section are abutted against each other and are connected by a thread, the seam also comprising a dustcover system comprising a first dustcover section connected to the first section and a second dustcover section connected to the second section, wherein the abutted seam is at least partially covered by a part of the first dustcover section and a part of the second dustcover section.

2. The protective barrier as recited in claim 1, wherein when the first section and second section are comprised of polyethylene.

3. The protective barrier as recited in claim 1, wherein when the first dustcover section and second dustcover section are each comprised of polyethylene.

4. The protective barrier as recited in claim 1, wherein when the first dustcover section is connected to the first section by a layer of adhesive and second dustcover section is connected to the second section by a layer of adhesive.

5. The protective barrier as recited in claim 1, wherein when the first dustcover section is connected to the first section by an ultrasonic-welded seam and second dustcover section is connected to the second section by an ultrasonic-welded seam.

6. The protective barrier as recited in claim 1, wherein when the first dustcover section is connected to the first section by a heat-welded seam and second dustcover section is connected to the second section by a heat-welded seam.

7. The protective barrier as recited in claim 1, wherein the thread is comprised of a heat-sensitive material such as a copolyamide.

8. The protective barrier as recited in claim 1, wherein the thread is comprised of the heat-sensitive material polycaprolactone.

9. The protective barrier as recited in claim 1, wherein the thread is comprised of a water-soluble material such as a polyvinyl alcohol.

10. A protective barrier, comprising:
a first section and a second section connected by an overlapping seam where the first section and second section overlap each other and are connected by a thread, the seam also comprising a dustcover system comprising a first dustcover section connected to the first section and a second dustcover section connected to the second section, wherein the overlapping seam is at least partially covered by a part of the first dustcover section and a part of the second dustcover section.

11. The protective barrier as recited in claim 10, wherein when the first section and second section are comprised of polyethylene.

12. The protective barrier as recited in claim 10, wherein when the first dustcover section and second dustcover section are each comprised of polyethylene.

13. The protective barrier as recited in claim 10, wherein when the first dustcover section is connected to the first section by a layer of adhesive and second dustcover section is connected to the second section by a layer of adhesive.

14. The protective barrier as recited in claim 10, wherein when the first dustcover section is connected to the first section by an ultrasonic-welded seam and second dustcover section is connected to the second section by an ultrasonic-welded seam.

15. The protective barrier as recited in claim 10, wherein when the first dustcover section is connected to the first section by a heat-welded seam and second dustcover section is connected to the second section by a heat-welded seam.

16. The protective barrier as recited in claim 10, wherein the thread is comprised of a heat-sensitive material such as a copolyamide.

17. The protective barrier as recited in claim 10, wherein the thread is comprised of the heat-sensitive material polycaprolactone.

18. The protective barrier as recited in claim 10, wherein the thread is comprised of a water-soluble material such as a polyvinyl alcohol.

19. A method for constructing a protective barrier, the method comprising:
providing parts of a protective barrier, comprising a first section and a second section, a dustcover system comprising a first dustcover section and a second dustcover section, adhesive, and a thread;
abutting the first section against the second section and sewing the first section and second section together with the thread creating an abutted seam;
connecting the first dustcover section to the first section with adhesive so that at least part of the first dustcover section covers the abutted seam; and
connecting the second dustcover section to the second section with adhesive so that at least part of the second dustcover section covers the abutted seam.

20. The protective barrier as recited in claim 19, wherein the thread is comprised of a copolyamide.
